(19) United States
(12) Patent Application Publication
(10) Pub. No.: US 2019/0099828 A1
(43) Pub. Date: Apr. 4, 2019

(54) JOINING-MEMBER WELDING UNIT

(71) Applicant: TOYOTA JIDOSHA KABUSHIKI KAISHA, Toyota-shi (JP)

(72) Inventor: Motomu IITSUKA, Nishio-shi (JP)

(73) Assignee: TOYOTA JIDOSHA KABUSHIKI KAISHA, Toyota-shi (JP)

(21) Appl. No.: 16/115,951

(22) Filed: Aug. 29, 2018

(30) Foreign Application Priority Data
Oct. 4, 2017 (JP) 2017-194184

(51) Int. Cl. B23K 11/00; F16B 19/06; F16B 5/08

(52) U.S. Cl. CPC B23K 11/0053; F16B 5/08; F16B 19/06; B23K 11/0066

(57) ABSTRACT

A joining-member welding unit includes a first member made of metal, a second member overlapped with one surface of the first member, a joining member made of the same kind of metal as the first member, and a welder. The second member has a through-hole defined by an inner wall surface thereof. The inner wall surface and the one surface define a recessed portion. The joining member includes a large-diameter plate portion having an outer diameter larger than a diameter of the through-hole and a thickness smaller than the diameter of the through-hole, and a protruding portion protruding from the large-diameter plate portion and to be inserted into the through-hole. The welder includes a holding portion that holds the joining member. The welder applies an electric current to the joining member to melt the protruding portion such that the first member and the second member are joined together.

### INCORPORATION BY REFERENCE

The disclosure of Japanese Patent Application No. 2017-194184 filed on Oct. 4, 2017 including the specification, drawings and abstract is incorporated herein by reference in its entirety.

### BACKGROUND

### 1. Technical Field

The disclosure relates to a joining-member welding unit in which welding is performed to join a plurality of members together through the use of a joining member, such as a rivet or a stud.

### 2. Description of Related Art

Japanese Unexamined Patent Application Publication No. 53-033951 (JP 53-033951 A) describes an apparatus in which a first member and a second member are joined together through the use of a fixing member. The fixing member is integral with a cylindrical rod. The fixing member is fitted into an opening provided in one of the first member and the second member. Then, an electric current is supplied from a stud device to the fixing member through the rod, so that the objects to be joined together are welded together. Usually, the rod is removed after joining of the first member and the second member is completed.

### SUMMARY

However, the foregoing related art still has room for improvement in the following respects. In order to remove the rod, it is necessary to perform a work of detaching the rod from the fixing member. This work requires a lot of time and effort. On the other hand, when the rod is left unremoved after the first member and the second member are joined together, the rod becomes an undesired protrusion, resulting in poor appearance of a joining region. Further, there is a possibility that the unremoved rod interferes with other member.

The disclosure provides a joining-member welding unit in which joining of a plurality of members is easily performed such that a joining region presents a good appearance and the joining region can avoid an interference with other member.

An aspect of the disclosure relates to a joining-member welding unit including a first member made of metal, a second member overlapped with one surface of the first member, a joining member made of the same kind of metal as the metal of the first member, and a welder. The second member has a through-hole defined by an inner wall surface of the second member. The inner wall surface of the second member and the one surface of the first member define a recessed portion. The joining member includes a large-diameter plate portion and a protruding portion. The large-diameter plate portion has an outer diameter larger than a diameter of the through-hole. The large-diameter plate portion has a thickness smaller than the diameter of the through-hole. The protruding portion protrudes from the large-diameter plate portion. The protruding portion is configured to be inserted into the through-hole. The welder includes a holding portion configured to hold the joining member. The welder is configured to apply an electric current to the joining member to melt the protruding portion of the joining member such that the first member and the second member are joined together.

In the joining-member welding unit according to the above aspect of the disclosure, the joining member is held by the holding portion of the welder, and the protruding portion of the joining member is inserted into the recessed portion defined by the one surface of the first member and the inner wall surface the second member, which define the through-hole. Then, the welder applies an electric current to the joining member, so that the joining member and the one surface of the first member are melted. Thus, the joining member and the first member are welded together, so that the second member is sandwiched between the large-diameter plate portion and the first member. As a result, the first member and the second member are joined together.

According to the above aspect of the disclosure, it is possible to easily perform welding with the joining member held by the holding portion of the welder. Because the thickness of the large-diameter plate portion is smaller than the diameter of the through-hole, the amount by which the joining member protrudes from the second member after welding is small. As a result, a joining region presents a good appearance.

In the joining-member welding unit according to the above aspect of the disclosure, a protruding length of the protruding portion may be larger than a depth of the recessed portion. The protruding length is a length by which the protruding portion protrudes from the large-diameter plate portion.

With this configuration, it is possible to secure a space where an arc discharge is generated by application of an electric current for performing welding, and to reduce the length of the protruding portion by melting, thereby appropriately performing welding.

In the joining-member welding unit according to the above aspect of the disclosure, an engagement recessed portion to be engaged with the holding portion may be provided in a surface of the large-diameter plate portion.

With this configuration, when the engagement recessed portion provided in the surface of the large-diameter plate portion and the holding portion are engaged with each other, the large-diameter plate portion and the holding portion can be easily aligned with each other and the joining member can be held by the holding portion.

In the joining-member welding unit according to the above aspect of the disclosure, the holding portion of the welder may be a vacuum holding portion configured to hold the joining member by vacuum suction.

With this configuration, the holding portion can easily hold the joining member by vacuum suction.

In the joining-member welding unit according to the above aspect of the disclosure, the holding portion of the welder may be a magnetic holding portion configured to hold the joining member by magnetically (e.g., electromagnetically) attracting the joining member.

With this configuration, the holding portion can easily hold the joining member by magnetically attracting the joining member.

In the joining-member welding unit according to the above aspect of the disclosure, the holding portion of the welder may be provided with an external thread, and an internal thread to which the external thread is to be screwed may be provided in a surface of the large-diameter plate portion.

With this configuration, the holding portion can easily hold the joining member when the external thread is screwed to the internal thread.

In the joining-member welding unit according to the above aspect of the disclosure, the holding portion of the welder may include a spring member that is elastically deformable in a radial direction of the holding portion, and an engagement groove with which the spring member is to be engaged by being compressively deformed may be provided in a surface of the large-diameter plate portion.

With this configuration, the holding portion can easily hold the joining member with the use of the elastically deformable spring member.

As described above, in the joining-member welding unit according to the above aspect of the disclosure, joining of a plurality of members is easily performed such that a joining region presents a good appearance.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a partial sectional view of a joining-member welding unit according to a first embodiment;

FIG. 2A is a view illustrating a joining step performed by the joining-member welding unit according to the first embodiment (before application of an electric current);

FIG. 2B is a view illustrating a joining step performed by the joining-member welding unit according to the first embodiment (before application of an electric current);

FIG. 3A is a view illustrating a joining step performed by the joining-member welding unit according to the first embodiment (after application of an electric current);

FIG. 3B is a view illustrating a joining step performed by the joining-member welding unit according to the first embodiment (after application of an electric current);

FIG. 4A is a partial sectional view of a joining-member welding unit according to a modified example of the first embodiment;

FIG. 4B is a partial sectional view of a joining-member welding unit according to another modified example of the first embodiment;

FIG. 5 is a partial sectional view of a joining-member welding unit according to a second embodiment; and

FIG. 6 is a partial sectional view of a joining-member welding unit according to a third embodiment.

### DETAILED DESCRIPTION OF EMBODIMENTS

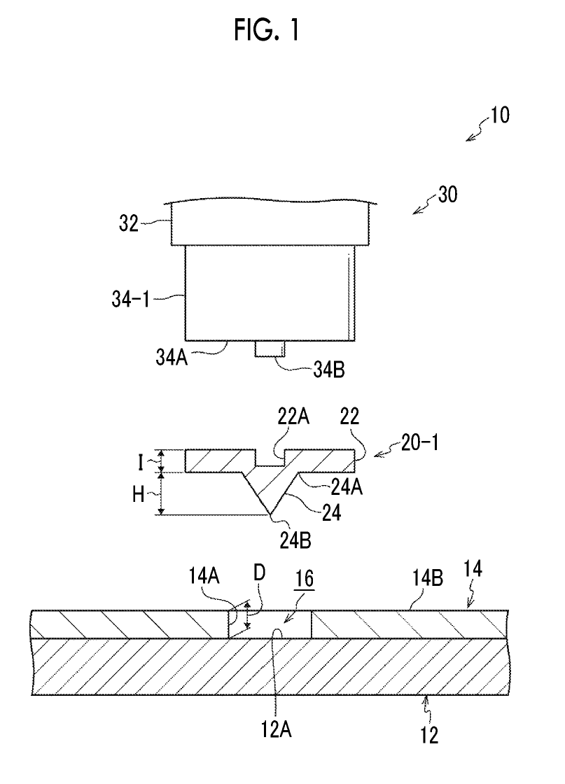

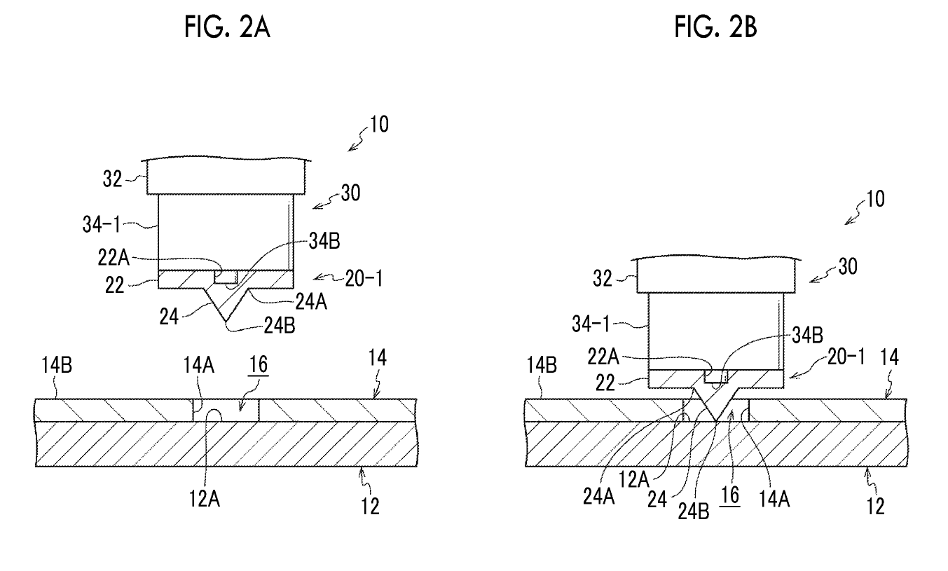

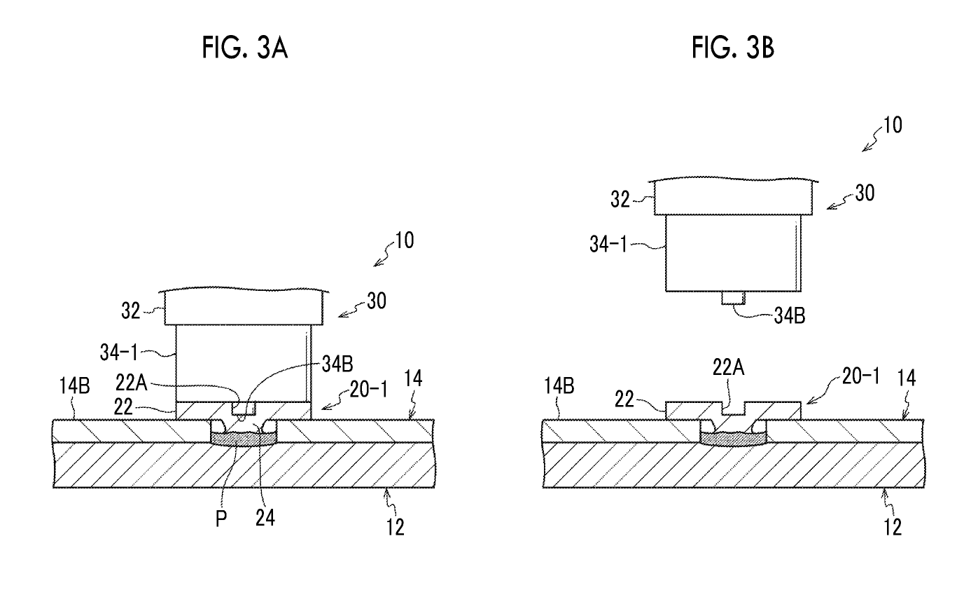

Hereinafter, a joining-member welding unit 10 according to a first embodiment of the disclosure will be described with reference to FIG. 1, FIG. 2A, FIG. 2B, FIG. 3A, and FIG. 3B.

As illustrated in FIG. 1, the joining-member welding unit 10 according to the first embodiment includes a first member 12, a second member 14 made of a different kind of material from that of the first member 12, a joining member 20-1 made of the same kind of material as that of the first member 12, and a welder 30.

In the first embodiment, the first member 12 is made of, for example, an iron-based metal material. The second member 14 is made of a different kind of material from that of the first member 12. In the first embodiment, the second member 14 is made of an aluminum alloy, which is a material different from an iron-based metal material. Alternatively, the second member 14 may be made of a lightweight material, such as carbon fiber reinforced plastic (CFRP), or a magnesium alloy. The first member 12 and the second member 14 may be made of the same kind of metal material.

The joining member 20-1 is made of the same kind of material as that of the first member 12. In the first embodiment, the joining member 20-1 is made of an iron-based metal material.

The second member 14 is in the form of a plate. The second member 14 is overlapped with a flat portion of the first member 12. The second member 14 has a through-hole 14A. The through-hole 14A is defined by an inner wall surface of the second member 14. A recessed portion 16 is defined by the inner wall surface of the second member 14 and one surface 12A of the first member 12, which faces the through-hole 14A.

The joining member 20-1 includes a large-diameter plate portion 22 having a disk shape, and a protruding portion 24 protruding from a center portion of the large-diameter plate portion 22. The outer diameter of the large-diameter plate portion 22 is larger than the diameter of the through-hole 14A. The protruding portion 24 is a solid conical portion. In the protruding portion 24, a portion on the large-diameter plate portion 22-side is a base portion 24A, and a tip end portion in the protruding direction is an apex portion 24B. The protruding portion 24 is integral with the large-diameter plate portion 22. The outer diameter of the base portion 24A of the protruding portion 24 is smaller than the diameter of the through-hole 14A.

A thickness I of the large-diameter plate portion 22 is smaller than the diameter of the through-hole 14A. That is, the thickness I of the large-diameter plate portion 22 is set to be smaller than the outer diameter of a nugget formed by welding (described later). A height H of the protruding portion 24, that is, a protruding length H by which the protruding portion 24 protrudes from the large-diameter plate portion 22, is larger than a depth D of the through-hole 14A, that is, a thickness D of the second member 14. The height H of the protruding portion 24 is smaller than twice the depth D of the through-hole 14A. In an upper surface of the large-diameter plate portion 22, which is on the opposite side of the large-diameter plate portion 22 from the protruding portion 24, an engagement recessed portion 22A is provided at a position corresponding to the protruding portion 24. The engagement recessed portion 22A is a columnar recess. The depth of the engagement recessed portion 22A is smaller than the thickness I of the large-diameter plate portion 22. The thickness of the first member 12 may be set to, for example, about 1 mm to about 2 mm. The thickness D of the second member 14 (the depth D of the through-hole 14A) may be set to about 0.6 mm to about 3 mm. The diameter of the through-hole 14A may be set to about 5 mm to about 10 mm. However, the thickness of the first member 12, the thickness D of the second member 14 (the depth D of the through-hole 14A), and the diameter of the through-hole 14A are not limited to these values.

The welder 30 includes a body portion 32 and a holding portion 34-1. The holding portion 34-1 is configured to hold the joining member 20-1. The holding portion 34-1 includes a contact surface 34A to be brought into contact with the large-diameter plate portion 22, and an engagement protruding portion 34B to be inserted into the engagement recessed portion 22A. The engagement protruding portion 34B has a columnar shape corresponding to the shape of the engagement recessed portion 22A. The body portion 32 is a body of a stud welder including a circuit configured to apply an electric current to the joining member 20-1 via the holding portion 34-1, and a driving portion configured to control operations, such as an operation of pushing the holding portion 34-1 and an operation of lifting up the holding portion 34-1. The holding portion 34-1 is configured to electromagnetically attract and hold the joining member 20-1 when a switch of the welder 30 is turned on. Further, the holding portion 34-1 is configured to stop holding the joining member 20-1, so that the joining member 20-1 is detached from the holding portion 34-1, when the switch is turned off.

Next, joining steps performed by the joining-member welding unit 10 according to the first embodiment will be described.

As illustrated in FIG. 2A, the first member 12 and the second member 14 are aligned and overlapped with each other. As a result, the recessed portion 16 is defined by the inner wall surface of the second member 14, which defines the through-hole 14A, and the one surface 12A of the first member 12, which faces the through-hole 14A.

The joining member 20-1 is held by the holding portion 34-1 of the welder 30. Specifically, the engagement protruding portion 34B is inserted into the engagement recessed portion 22A of the joining member 20-1, the contact surface 34A of the holding portion 34-1 is brought into contact with the upper surface of the large-diameter plate portion 22 of the joining member 20-1, and then the switch of the welder 30 is turned on. As a result, the joining member 20-1 is electromagnetically attracted to and held by the holding portion 34-1.

Then, the protruding portion 24 is inserted into the recessed portion 16 while the joining member 20-1 is held by the holding portion 34-1. Then, as illustrated in FIG. 2B, the apex portion 24B of the joining member 20-1 is brought into contact with the one surface 12A of the first member 12. Then, an electric current is applied to the joining member 20-1. In the case of arc welding, the joining member 20-1 is slightly lifted up from the one surface 12A of the first member 12, and an arc discharge is generated between the apex portion 24B and the one surface 12A of the first member 12. In this way, the apex portion 24B of the protruding portion 24 and the one surface 12A of the first member 12 are melted.

Then, as illustrated in FIG. 3A, the holding portion 34-1 is lowered (i.e., is brought close to the first member 12), so that the protruding portion 24 of the joining member 20-1 is pushed into a molten pool P. When a lower surface of the large-diameter plate portion 22 comes into contact with a surface 14B of the second member 14, application of an electric current is stopped. Thus, the protruding portion 24 is welded in the recessed portion 16, so that the second member 14 is sandwiched between the large-diameter plate portion 22 and the first member 12. As a result, the first member 12 and the second member 14 are joined together via the large-diameter plate portion 22.

Then, the switch of the welder 30 is turned off. As a result, the holding portion 34-1 stops holding the joining member 20-1, so that the joining member 20-1 is detached from the holding portion 34-1, as illustrated in FIG. 3B.

With the joining-member welding unit 10 according to the first embodiment, it is possible to perform welding easily with the joining member 20-1 held by the holding portion 34-1 of the welder 30. In addition, the thickness I of the large-diameter plate portion 22 is smaller than the diameter of the through-hole 14A. Thus, the amount by which the joining member 20-1 protrudes from the second member 14 after welding is small. As a result, a joining region presents a good appearance.

The amount by which the joining member 20-1 protrudes from the second member 14 is small. Therefore, it is possible to use the joining member 20-1 for a door opening flange or the like, for which a blind rivet that protrudes by a large amount cannot be used.

With the joining-member welding unit according to the first embodiment, the first member 12 and the second member 14 can be joined together through access from one side at a joining site. Therefore, it is possible to perform a joining work more easily than a case where a joining unit that needs access from both sides is used.

In the joining-member welding unit 10, the protruding length H of the protruding portion 24 is larger than the depth D of the recessed portion 16. Thus, the large-diameter plate portion 22 can be kept apart from the second member 14 before the protruding portion 24 is melted. In addition, the protruding length H of the protruding portion 24 is smaller than twice the depth D of the recessed portion 16. Because the protruding portion 24 is not excessively long, it is possible to prevent the first member 12 and the joining member 20-1 from being welded together in a state where the large-diameter plate portion 22 is distant from the surface 14B of the second member 14. The protruding length H of the protruding portion 24 need not be smaller than twice the depth D of the recessed portion 16.

In the joining-member welding unit 10, a joining work is performed with the large-diameter plate portion 22 having a disk shape held by the holding portion 34-1 of the welder 30. Therefore, it is not necessary to hold a protruding portion of, for example, a stud bolt while performing a joining work, and to remove the protruding portion after the joining work. As a result, it is possible to easily perform a joining work.

In the first embodiment, the joining member 20-1 is electromagnetically held by the holding portion 34-1. Alternatively, the joining member 20-1 may be held by the holding portion 34-1, for example, by vacuum suction.

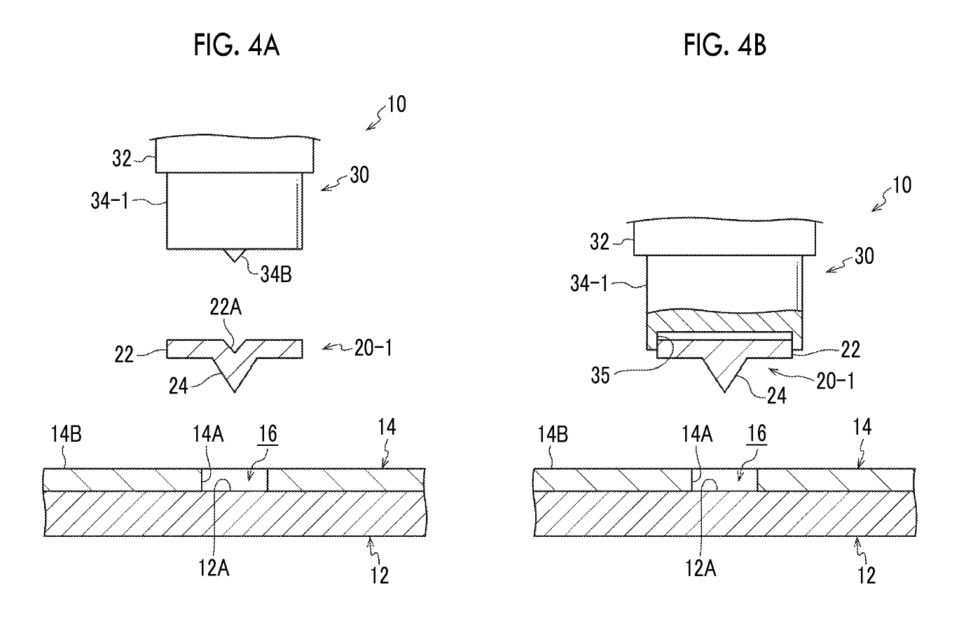

In the first embodiment, the engagement recessed portion 22A, which is a columnar recess, is provided in the large-diameter plate portion 22 of the joining member 20-1. Further, the engagement protruding portion 34B having a columnar shape corresponding to the shape of the engagement recessed portion 22A is provided. Alternatively, as illustrated in FIG. 4A, the engagement recessed portion 22A may be a conical recess, and the engagement protruding portion 34B may have a conical shape.

As illustrated in FIG. 4B, an engagement recessed portion 35 may be provided in the holding portion 34-1, so that the large-diameter plate portion 22 is held in the engagement recessed portion 35. Alternatively, both the holding portion 34-1 and the large-diameter plate portion 22 may have a flat shape without being provided with a recess or a protrusion, and the holding portion 34-1 may magnetically hold the large-diameter plate portion 22.

In the first embodiment, in arc welding, an electric current is applied to the joining member 20-1 and then the first member 12 and the apex portion 24B of the joining member 20-1 are slightly separated from each other. Alternatively, capacitor discharge welding may be performed. In the case of contact capacitor discharge welding, an electric current is applied to the joining member 20-1 with the apex portion 24B kept in contact with the first member 12, so that the protruding portion 24 and the one surface 12A of the first member 12 are melted. Then, the joining member 20-1 is pushed toward the first member 12. As a result, the joining member 20-1 is welded to the first member 12. In the case of gap capacitor discharge welding, the joining member 20-1 is brought close to the first member 12 while an electric current is applied to the joining member 20-1, so that the protruding portion 24 and the one surface 12A of the first member 12 are melted. Then, the joining member 20-1 is pushed toward the first member 12. As a result, the joining member 20-1 is welded to the first member 12.

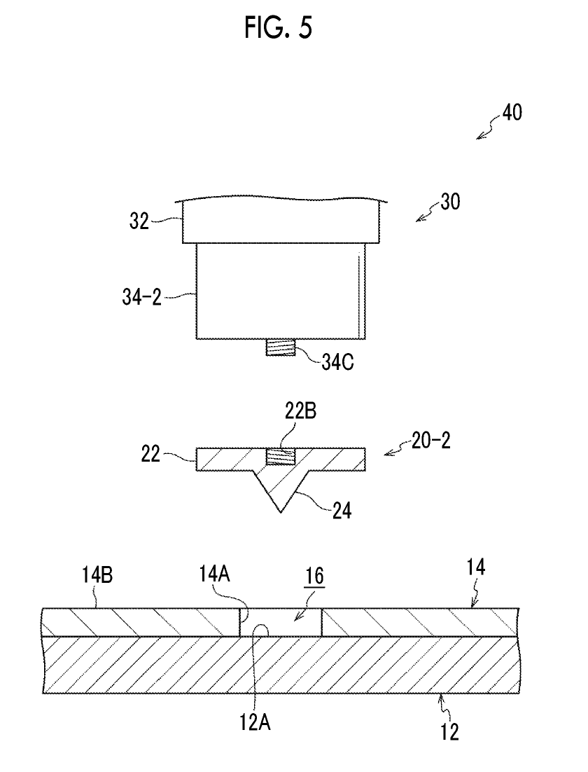

Next, a joining-member welding unit 40 according to a second embodiment of the disclosure will be described with reference to FIG. 5. Note that the same elements as those in the first embodiment will be denoted by the same reference signs as those in the first embodiment, and detailed description thereof will be omitted.

As illustrated in FIG. 5, the joining-member welding unit 40 according to the second embodiment includes a joining member 20-2 including an internally-threaded engagement recessed portion 22B that differs in configuration from the engagement recessed portion 22A of the joining member 20-1 in the first embodiment. The joining-member welding unit 40 according to the second embodiment includes a holding portion 34-2 including an externally-threaded engagement protruding portion 34C that differs in configuration from the engagement protruding portion 34B of the holding portion 34-1 in the first embodiment.

The internally-threaded engagement recessed portion 22B is provided in the large-diameter plate portion 22 of the joining member 20-2. An internal thread is provided in the inner peripheral wall of the large-diameter plate portion 22, which defines the internally-threaded engagement recessed portion 22B. The holding portion 34-2 includes the externally-threaded engagement protruding portion 34C. The externally-threaded engagement protruding portion 34C is provided with an external thread to be screwed to the internally-threaded engagement recessed portion 22B.

The externally-threaded engagement protruding portion 34C is screwed to the internally-threaded engagement recessed portion 22B, so that the joining member 20-2 is held by the holding portion 34-2. In this state, the protruding portion 24 is inserted into the recessed portion 16 and a welding work is performed, as in the first embodiment. In order to detach the joining member 20-2 from the holding portion 34-2, the externally-threaded engagement protruding portion 34C is rotated in a direction opposite to the direction in which the externally-threaded engagement protruding portion 34C is screwed to the internally-threaded engagement recessed portion 22B, so that the externally-threaded engagement protruding portion 34C is unscrewed from the internally-threaded engagement recessed portion 22B.

In the joining-member welding unit 40 according to the second embodiment, the joining member 20-2 is held by the holding portion 34-2 through screwing. This makes the configuration of the welder 30 simple.

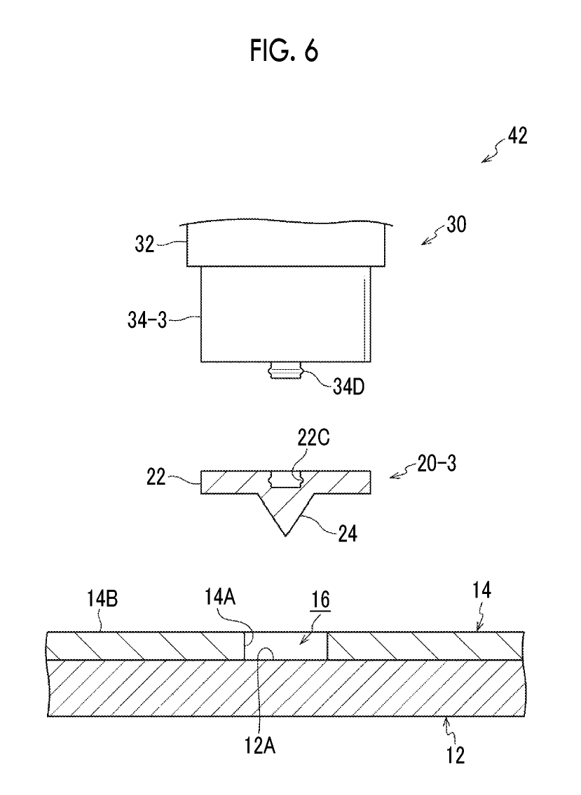

A joining-member welding unit 42 according to a third embodiment of the disclosure will be described with reference to FIG. 6. Note that the same elements as those in the first and second embodiments will be denoted by the same reference signs as those in the first and second embodiments, and detailed description thereof will be omitted.

As illustrated in FIG. 6, the joining-member welding unit 42 according to the third embodiment includes a joining member 20-3 including an engagement recessed portion that differs in configuration from the engagement recessed portion 22A of the joining member 20-1 in the first embodiment. The joining-member welding unit 42 according to the third embodiment includes a holding portion 34-3 including an engagement protruding portion that differs in configuration from the engagement protruding portion 34B of the holding portion 34-1 in the first embodiment.

An engagement groove 22C is provided in the large-diameter plate portion 22 of the joining member 20-3. The configuration of the engagement recessed portion in the third embodiment is the same as that of the engagement recessed portion 22A in the first embodiment, except that the engagement groove 22C is provided in the third embodiment. The engagement groove 22C is a groove that has a triangular section and that is provided in the inner peripheral wall of the large-diameter plate portion 22, which defines the engagement recessed portion in the first embodiment. The engagement groove 22C extends along the entire circumference of the inner peripheral wall of the large-diameter plate portion 22. The holding portion 34-3 includes a plurality of engagement spring portions 34D aligned in the circumferential direction of the engagement protruding portion 34B. The configuration of the engagement protruding portion in the third embodiment is the same as the configuration of the engagement protruding portion 34B in the first embodiment, except that the engagement spring portions 34D are provided on the outer periphery of the engagement protruding portion in the third embodiment. Each of the engagement spring portions 34D is an elastically-deformable leaf spring that is to be engaged with the engagement groove 22C. The engagement spring portions 34D are elastically deformable in the radial direction of the holding portion 34-3.

The engagement spring portions 34D are pushed into the engagement groove 22C while being elastically deformed inward in the radial direction of the holding portion 34-3, so that the joining member 20-3 is held by the holding portion 34-3. As a result, the engagement spring portions 34D are compressively deformed and engaged with the engagement groove 22C. In this state, the protruding portion 24 is inserted into the recessed portion 16 and a welding work is performed, as in the first embodiment. In order to detach the joining member 20-3 from the holding portion 34-3, the engagement spring portions 34D are moved in a direction opposite to the direction in which the engagement spring portions 34D are engaged with the engagement groove 22C.

In the joining-member welding unit 42 according to the third embodiment, the leaf springs are used to cause the holding portion 34-3 to hold the joining member 20-3. This makes the configuration of the welder 30 simple.

What is claimed is:

1. A joining-member welding unit comprising:
a first member made of metal;
a second member overlapped with one surface of the first member, the second member having a through-hole defined by an inner wall surface of the second member, the inner wall surface of the second member and the one surface of the first member defining a recessed portion;
a joining member made of the same kind of metal as the metal of the first member, the joining member including a large-diameter plate portion and a protruding portion, the large-diameter plate portion having an outer diameter larger than a diameter of the through-hole, the large-diameter plate portion having a thickness smaller than the diameter of the through-hole, the protruding portion protruding from the large-diameter plate portion, and the protruding portion being configured to be inserted into the through-hole; and
a welder including a holding portion configured to hold the joining member, and the welder configured to apply an electric current to the joining member to melt the protruding portion of the joining member such that the first member and the second member are joined together.

2. The joining-member welding unit according to claim 1, wherein a protruding length of the protruding portion is larger than a depth of the recessed portion, the protruding length being a length by which the protruding portion protrudes from the large-diameter plate portion.

3. The joining-member welding unit according to claim 1, wherein an engagement recessed portion to be engaged with the holding portion is provided in a surface of the large-diameter plate portion.

4. The joining-member welding unit according to claim 1, wherein the holding portion of the welder is a vacuum holding portion configured to hold the joining member by vacuum suction.

5. The joining-member welding unit according to claim 1, wherein the holding portion of the welder is a magnetic holding portion configured to hold the joining member by magnetically attracting the joining member.

6. The joining-member welding unit according to claim 1, wherein:
the holding portion of the welder is provided with an external thread; and
an internal thread to which the external thread is to be screwed is provided in a surface of the large-diameter plate portion.

7. The joining-member welding unit according to claim 1, wherein:
the holding portion of the welder includes a spring member that is elastically deformable in a radial direction of the holding portion; and
an engagement groove with which the spring member is to be engaged by being compressively deformed is provided in a surface of the large-diameter plate portion.
